(19) United States
(12) Patent Application Publication
(10) Pub. No.: US 2016/0350292 A1
(43) Pub. Date: Dec. 1, 2016

(54) METHOD AND APPARATUS FOR REAL-TIME DATA MIGRATION

(71) Applicant: Alibaba Group Holding Limited, Grand Cayman (KY)

(72) Inventor: Junze YU, Chengdu (CN)

(21) Appl. No.: 15/166,067

(22) Filed: May 26, 2016

(30) Foreign Application Priority Data
May 27, 2015 (CN) 201510278987.8

(51) Int. Cl. G06F 17/30

(52) U.S. Cl. CPC G06F 17/303; G06F 17/30575

(57) ABSTRACT

A method for real-time data migration is disclosed. The method includes monitoring a data request volume; determining first hotspot data based on the monitored data request volume; adding a data identifier of the first hotspot data into a migration list and starting a process of migrating the first hotspot data to a first database. Thereby, effects of releasing the work thread resources of a server are achieved, thus easing the pressure of the server and maintaining normal operations of data processing.

### CROSS REFERENCE TO RELATED PATENT APPLICATION

This application claims foreign priority to Chinese Patent Application No. 201510278987.8 filed on May 27, 2015, entitled “Method and Apparatus for Real-Time Migration”, which is hereby incorporated by reference in its entirety.

### TECHNICAL FIELD

The present disclosure relates to the field of Internet technologies and in particular, to methods and apparatuses for real-time data migration.

### BACKGROUND

With the development of the Internet, the number of Internet users is constantly increasing, leading to a sharp increase in the access volume of websites. Accordingly, providers adopted a server mirror technology, in which buffer devices are placed at locations where users are relatively concentrated to serve as a mirror server for an original server, and a user is re-directed to the mirror server that is nearest to the user by a network when accessing the original server, thereby improving the access quality and access speed of network users.

However, due to the recent booming of Internet applications such as e-commerce and social platforms, phenomena of concentrated network hot spots and higher switching frequencies occur. A high instant concurrency of certain data in a website database and a sharp increase in the number of requests for performing a write operation on the data frequently occur. This causes a great number of requests to wait for performing a row lock on the data in the database, and occupies the work thread resource of the database. However, the work thread resource of the database is limited. For example, a system throughput of a database may be 7000 tps, and ten pieces of hotspot data may currently exist in the database. A concurrency number of each piece of hotspot data achieves 1000 tps, such that a concurrency number of ten pieces of hotspot data achieves 10000 tps, which exceeds the system throughput. This leads to a failure in releasing the work thread of the database which then becomes unavailable, and thus affects the processing of other non-hotspot data.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

In view of the foregoing, the present disclosure provides a method and an apparatus for real-time data migration, which solve a technical problem of unavailability of a database due to an instant occurrence of hotspot data.

In order to solve the above technical problem, the present disclosure provides a method for real-time data migration, which may include monitoring a data request volume; determining first hotspot data according to the monitored data request volume; adding a data identifier of the first hotspot data into a migration list, and starting a process of migrating the first hotspot data to a first database.

In implementations, the method may further include determining whether the process of migrating the first hotspot data to the first database is completed, and deleting the data identifier of the first hotspot data from the migration list and adding the data identifier of the first hotspot data into a preset first hotspot data list after the process of migrating the first hotspot data to the first database is completed.

In implementations, the method may further include determining whether a received request for the first hotspot data is a write request if the process of migrating the first hotspot data to the first database is not completed; returning a message of write failure if the received request for the first hotspot data is a write request; and allowing a read operation on the first hotspot data if the received request for the first hotspot data is a read request.

In implementations, the method may further include obtaining load information of the first database; and determining second hotspot data that needs to be migrated from the first database to a second database according to the load information.

In implementations, determining the second hotspot data that needs to be migrated from the first database to the second database according to the load information may include obtaining a data lock queue from the load information; determining a number of ongoing sessions corresponding to each piece of first hotspot data according to the data lock queue; and setting piece(s) of first hotspot data having respective number(s) of ongoing sessions greater than a preset threshold as the second hotspot data that needs to be migrated from the first database to the second database.

After adding the data identifier of the first hotspot data into the preset first hotspot data list, the method may further include determining whether a request for the first hotspot data is received; and routing the request for the first hotspot data to the first database in response to receiving the request for the first hotspot data.

In implementations, the method may further include determining whether the received request is a request for the first hotspot data in the preset first hotspot data list; and routing the received request to the first database if the received request is a request for the first hotspot data in the preset first hotspot data list.

In order to solve the above technical problem, the present disclosure further provides an apparatus for real-time data migration, which may include a monitoring module to monitor a data request volume; a first determination module to determine first hotspot data according to the monitored data request volume; and a first processing module to add a data identifier of the first hotspot data into a migration list and start a process of migrating the first hotspot data to a first database.

In implementations, the apparatus may further include a first determination module to determine whether the process of migrating the first hotspot data to the first database is completed; a second processing module to delete the data identifier of the first hotspot data from the migration list and to add the data identifier of the first hotspot data into a preset first hotspot data list after the process of migrating the first hotspot data to the first database is completed.

In implementations, the apparatus may further include a second determination module to determine whether a received request for the first hotspot data is a write request if the process of migrating the first hotspot data to the first database is not completed; a third processing module to return a message of write failure if the received request for the first hotspot data is a write request; and a fourth processing module to allow a read operation on the first hotspot data if the received request for the first hotspot data is a read request.

In implementations, the apparatus may further include an acquisition module to obtain load information of the first database; and a second determination module to determine second hotspot data that needs to be migrated from the first database to a second database according to the load information.

In implementations, the second determination module may include an acquisition sub-module to obtain a data lock queue from the load information; a first determination sub-module to determine a number of ongoing sessions corresponding to each piece of first hotspot data according to the data lock queue; and a second determination sub-module to set piece(s) of first hotspot data having respective number(s) of ongoing sessions greater than a preset threshold as the second hotspot data that needs to be migrated from the first database to the second database.

In implementations, the apparatus may further include a third determination module to determine whether a request for the first hotspot data is received; and a first routing module to route the request for the first hotspot data to the first database in response to receiving the request for the first hotspot data.

In implementations, the apparatus may further include a fourth determination module to determine whether the received request is a request for the first hotspot data in the preset first hotspot data list; and a second routing module to route the received request to the first database if the received request is a request for the first hotspot data in the preset first hotspot data list.

Compared with existing technologies, the present disclosure can obtain the following technical effects: starting a process of migrating first hotspot data to a first database in response to detecting the first hotspot data to have a large data request volume, thereby releasing work thread resources of the server, alleviating the pressure of the server and maintaining normal operations of data processing.

Apparently, implementations of any product of the present disclosure are not needed to achieve all the above technical effects at one time.

### BRIEF DESCRIPTION OF THE DRAWINGS

Accompanying drawings described herein are intended to provide a further understanding on the present disclosure, and constitute a part of the present disclosure. Exemplary embodiments and a description thereof in the present disclosure are given to explain the present disclosure and are not to be construed as an improper limitation to the present disclosure.

FIG. 1 is a schematic flowchart of a method for real-time data migration according to an embodiment of the present disclosure.

FIG. 2 is a schematic flowchart of a method for re-migrating first hotspot data according to an embodiment of the present disclosure.

FIG. 3 is a schematic flowchart of a method for real-time data migration according to an embodiment of the present disclosure.

FIG. 4 is a schematic structural diagram of an apparatus for real-time data migration according to an embodiment of the present disclosure.

### DETAILED DESCRIPTION OF EMBODIMENTS

Implementations of the present disclosure are described in detail hereinafter in conjunction with the accompanying drawings and the embodiments to give a comprehensive understanding of how the present disclosure solves the technical problems and achieves the technical efficacy through technical means.

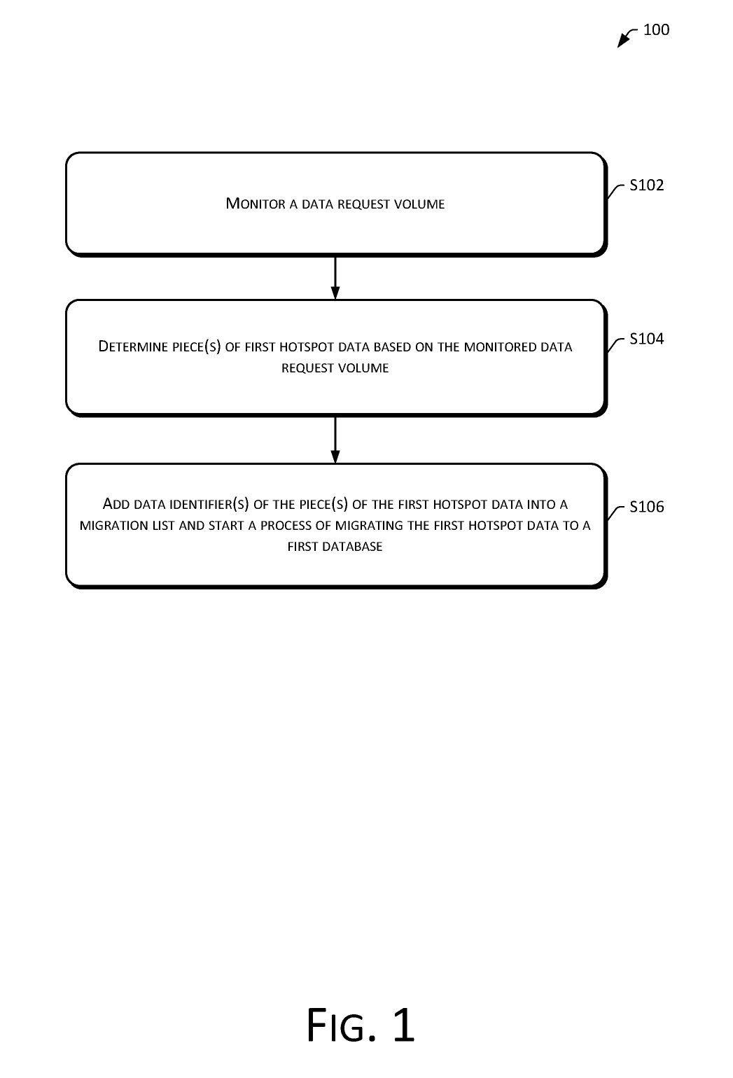

FIG. 1 shows a method 100 for real-time data migration according to an embodiment of the present disclosure, which is applicable in a server device. The method may include the following operations.

At S102, a data request volume is monitored.

The server device monitors a number of data requests that are received locally, including a read request and a write request for local data.

At S104, piece(s) of first hotspot data is/are determined based on the monitored data request volume.

For the server device, if a received data request is a write request, a row lock needs to be performed on associated data to prevent other write requests from performing a write operation on the data at the same time. On the other hand, since a read request for the data does not modify a value of the data, a plurality of requests are allowed to read the data at the same time. Therefore, if too many write requests for a same piece of data exist at the same time, a large number of write requests are in a waiting state, thereby occupying server thread resources. In order to avoid this type of scenario, first hotspot data is determined based on the monitored data request volume. The first hotspot data refers to data for which write requests are received at an overly high frequency. The server may monitor a respective number of write requests received within a unit time period (i.e., a frequency of write requests) for each piece of data, and treat piece(s) of data which frequency is greater than a threshold as the first hotspot data.

At S106, data identifier(s) of the piece(s) of the first hotspot data is/are added into a migration list, and a process of migrating the first hotspot data to a first database is started.

When a certain piece of data becomes first hotspot data, this indicates that this first hotspot data has occupied too many thread resources of the server, and thus brings an impact on the processing capability of the server. In this case, the first hotspot data needs to be migrated to a first database. The first database is used for processing data requests for the first hotspot data, with a data processing capability thereof being stronger than that of the server. When a certain piece of data is determined as the first hotspot data and needs to be migrated, the server adds a data identifier of that first hotspot data into a migration list, and starts a process of migrating the first hotspot data to the first database. The migration list is used for recording data identifiers of pieces of first hotspot data that are in a data migrating state, and the pieces of first hotspot data in the migration list correspond to pieces of first hotspot data that have started to migrate to the first database and have not yet finished a migrating process thereof.

After the data that becomes the first hotspot data is migrated out of the server, the work thread resources occupied by the first hotspot data can be released, thus effectively alleviating the pressure of the server and maintaining normal operations of other data processing of the server.

After starting the process of migrating the data that becomes the first hotspot data to the first database, the server determines whether the migrating process is completed. When the migrating process is not completed, the server determines whether a received request for the first hotspot data is a write request. If the received request is a write request, the server directly returns a message of write failure. If the received request is a read request, the server allows a read operation on the first hotspot data. Since the first hotspot data is in the process of migrating to the first database and a write request may involve modification(s) to the first hotspot data, a message of write failure is returned for all write requests for the first hotspot data. Because a read request does not involve any modification to the first hotspot data, a read operation on the first hotspot data is still allowed. The data in the server is recorded as individual pieces, a maximum number of pieces of data that can be migrated in each data migrating process may be 10, for example. Therefore, a duration during which the first hotspot data in the data migrating state is short, and the data migrating process is fast. A time instance during which returning a message of write failure occurs is of a millisecond level, and a few users may be affected by the data migrating process.

In response to determining that the migrating process is completed, the server deletes the data identifier of the first hotspot data from the migration list, and adds the data identifier of the first hotspot data into a preset first hotspot data list. The preset first hotspot data list is used for recording data identifiers of the first hotspot data stored in the first database. The above process represents a completion of the process of migrating the first hotspot data to the first database.

After the completion of the process of migrating the first hotspot data to the first database, the server determines whether a request for the first hotspot data is received. If a request for the first hotspot data is received, the request for the first hotspot data is routed to the first database. Because the first hotspot data is migrated to the first database, the server routes the request for the first hotspot data to the first database through a preset route table upon receiving the request for the first hotspot data, and the first database responds to the request for the first hotspot data, thus reducing the load of the server and maintaining effective operations of the server.

In implementations, a determination as to which data in the server most likely becomes the first hotspot data may be performed in advance. For example, a determination may be made that too many requests may exist for data according to expectations, and data identifiers of this data that most likely becomes the first hotspot data are added to a preset first hotspot data list in advance. Furthermore, the data may be initialized into the first database to avoid the impact on data processing of the server that is caused by an overly high data request volume in the future. Upon receiving a request for the data in the preset first hotspot data list, the server directly routes the request to the first database according to a preset route table, and the first database responds to the request for the data in the preset first hotspot data list.

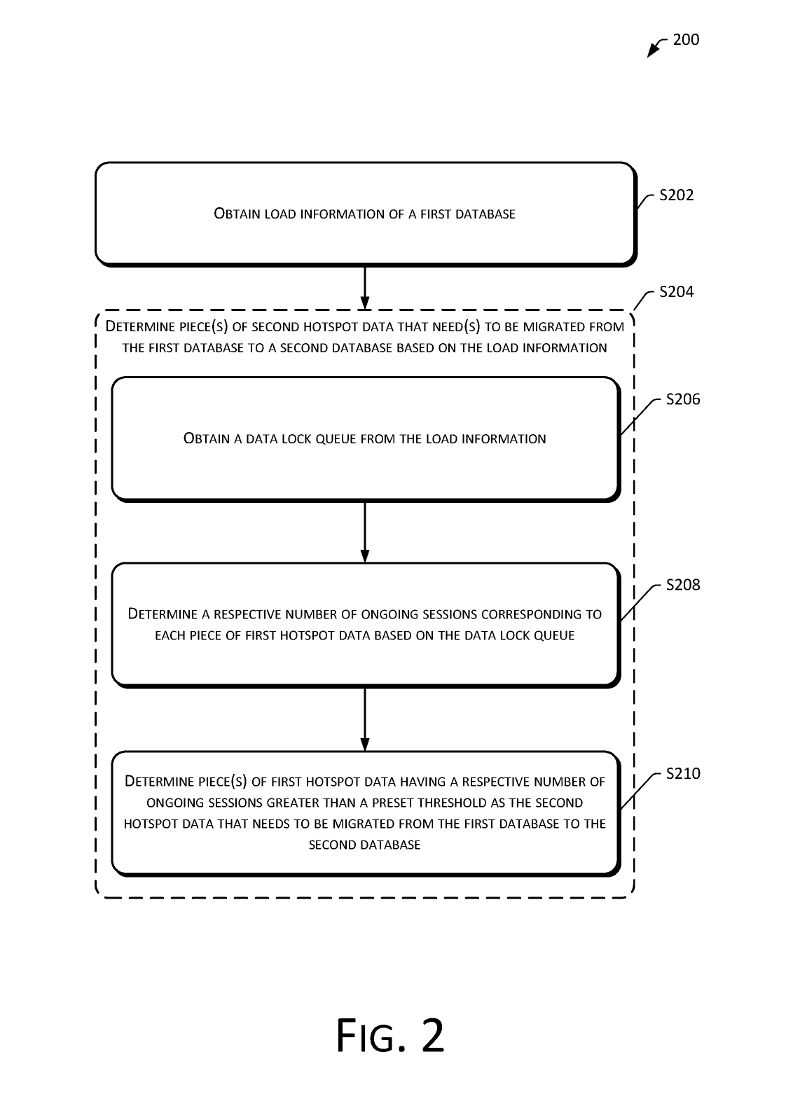

In implementations, when an amount of the first hotspot data in the first database increases in size or a number of requests continuously increases, the processing capability of the first database is also affected. Therefore, first hotspot data having a high request volume in the first database may need to be migrated again. FIG. 2 shows a migration method 200, which may include the following operations.

At S202, load information of the first database is obtained.

The load information includes information, such as a thread occupancy rate, a data lock queue, etc., of the first database. The load information of the first database may be obtained using monitoring and alarming software.

At S204, piece(s) of second hotspot data that need(s) to be migrated from the first database to a second database is determined based on the load information.

The second hotspot data refers to first hotspot data having a high or an increasing number of requests in the first database. When the workload of the first database is high and the processing capability thereof is affected, the second hotspot data needs to be migrated to a second database, and requests for the second hotspot data are then processed through the second database to reduce the workload of the first database. A method of determining second hotspot data that needs to be migrated to a second database may include the following operations.

At S206, a data lock queue is obtained from the load information.

A data lock is a lock mechanism for protecting shared resources. The lock mechanism protects the shared resources, such as data in a database to avoid updating the same data by two users at the same time. The data lock includes a first-in-first-out queuing mechanism, i.e., data is locked for a request that comes first, and a write operation is performed.

At S208, a respective number of ongoing sessions corresponding to each piece of first hotspot data is determined according to the data lock queue.

Each data lock queue of the first database is in correspondence with a piece of first hotspot data stored therein. Corresponding pieces of first hotspot data to which data requests received by the first database are directed can be determined through the data lock queue, and a number of ongoing sessions corresponding to each piece of first hotspot data can be further determined according to a number of sessions in the data lock queue.

At S210, piece(s) of first hotspot data having a respective number of ongoing sessions greater than a preset threshold may be determined as the second hotspot data that needs to be migrated from the first database to the second database.

A process of migrating the second hotspot data to the second database is the same as the aforementioned process of migrating the first hotspot data to the first database, and is not repeatedly described herein. The above process may re-migrate first hotspot data having a large number of data requests in a situation that the first database has an overly large workload pressure to alleviate the pressure on data processing of the first database.

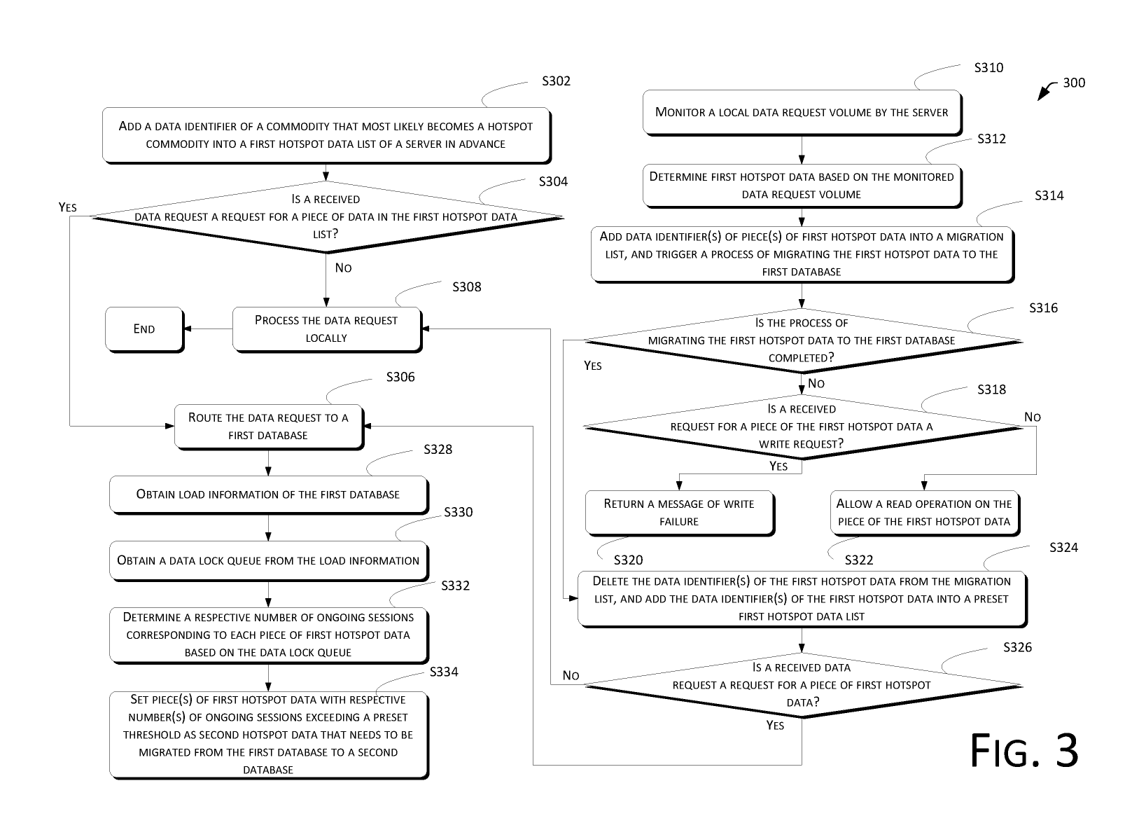

An application scenario is provided hereinafter to further illustrate the method for real-time data migration according to the embodiments of the present disclosure. In an online commodity sales system, merchants may launch promotions for certain online commodities, and a user may browse the commodities that are under promotion collectively and place an order in a short time. Browsing promotion information of a commodity belongs to a read operation on data of the commodity in an online sale server, and conducting an inventory reduction by the online sale server after an order is placed belongs to a write operation on the data of the commodity. During a promotional time period, a scenario in which a large number of users place orders for the commodities under promotion at the same time may occur. This causes the workload of the online sale server to become overwhelmed and the data processing to be slow, thus potentially affecting processing for other normal sales of commodity data. By using the method for real-time data migration according to the embodiments of the present disclosure, the pressure of the online commodity server can be alleviated. As shown in FIG. 3, an implementation process 300 may include the following operations.

At S302, a data identifier of a commodity that is most likely to become a hotspot commodity may be added into a first hotspot data list of a server in advance.

According to a promotional strategy of a merchant, commodities that are very likely to become hotspot commodities may be determined in advance, data identifiers of these types of commodities in server data may be added into a first hotspot data list in advance, and data of these types of commodities may be initialized into a first database.

At S304, a determination is made as to whether a received data request is a request for a piece of data in the first hotspot data list. Operation S306 is performed if the received data request is a request for a piece of data in the first hotspot data list. Operation S308 is performed if the received data request is not a request for any data in the first hotspot data list.

At S306, the data request is routed to the first database.

At S308, the data request is processed locally.

In additional or alternative implementations, the server may monitor a local data request volume at S310.

For example, for data of commodities which are not determined in advance as the hotspot commodities, the server may monitor respective numbers of data requests for these commodities in real time.

At S312, first hotspot data is determined based on the monitored data request volume.

Certain commodities may become hotspot commodities due to an instantaneous increase in respective numbers of data requests, and the server may set data of these commodities as first hotspot data.

At S314, data identifier(s) of piece(s) of the first hotspot data is/are added into a migration list, and a process of migrating the first hotspot data to a first database is started.

The server adds a data identifier of data of a commodity that becomes a hotspot commodity into a migration list, and starts a process of migrating the data of the commodity that becomes a hotspot commodity to the first database.

At S316, a determination is made as to whether the process of migrating the first hotspot data to the first database is completed. If the process of migrating the first hotspot data to the first database is not completed, S318 is performed. If the process of migrating the first hotspot data to the first database is completed, S324 is performed.

At S318, a determination is made as to whether a received request for a piece of the first hotspot data is a write request. If the received request for the piece of the first hotspot data is a write request, S320 is performed. If the received request for the piece of the first hotspot data is a read request, S322 is performed.

If migrating the data of the commodity that becomes a hotspot commodity to the first database is not completed, a determination is made as to whether there exists a user who makes an order on the commodity and browses information of the commodity.

At S320, a message of write failure is returned.

At S322, a read operation on the piece of the first hotspot data is allowed.

If the information of the commodity browsed by the user corresponds to a read request for the commodity data, such browsing is allowed. Making an order for the commodity by the user corresponds to a write request for the commodity data, a message of failure is thus directly returned, and the order for the commodity cannot be made currently.

At S324, the data identifier(s) of the piece(s) of the first hotspot data is/are deleted from the migration list, and the data identifier(s) of the piece(s) of the first hotspot data is/are added into a preset first hotspot data list.

After the migration of the data of the commodity that becomes a hotspot commodity to the first database is completed, the data identifier of the data of the commodity is deleted from the migration list, and is added into the preset first hotspot data list.

At S326, a determination as to whether a received data request is a request for the first hotspot data is made. In an event that the received data request is a request for the first hotspot data, S306 is performed. If the received data request is not a request for the first hotspot data, S308 is performed.

In response to receiving a new data request for the data of the commodity that becomes the hotspot commodity, the server may route the data request to the first data base.

At S328, load information of the first database is obtained.

The server obtains the load information of the first database to avoid a reduction in the processing capability of the first database due to an increase in the number of requests for the commodity data of the hotspot commodity.

At S330, a data lock queue is obtained from the load information.

At S332, a respective number of ongoing sessions corresponding to each piece of first hotspot data is determined based on the data lock queue.

At S334, piece(s) of first hotspot data with respective number(s) of ongoing sessions exceeding a preset threshold may be set as second hotspot data that needs to be migrated from the first database to the second database.

A determination of which commodity data in the first database that has an overly large number of requests and needs to be migrated again is made to ease the pressure of the first database.

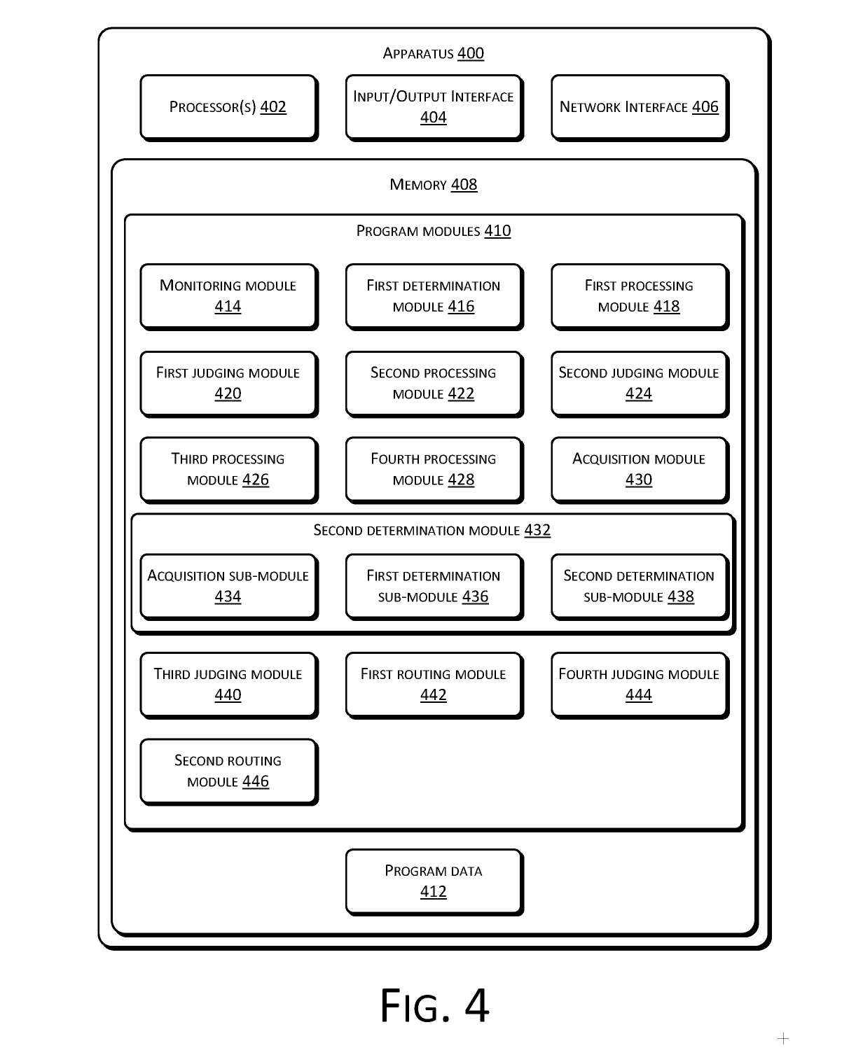

FIG. 4 shows an apparatus 400 for real-time data migration according to the embodiments of the present disclosure. By way of example and not limitation, the apparatus 400 may include one or more computing devices. In implementations, the apparatus 400 may include one or more processors 402, an input/output (I/O) interface 404, a network interface 406 and memory 408.

The memory 408 may include a form of computer-readable media, e.g., a non-permanent storage device, random-access memory (RAM) and/or a nonvolatile internal storage, such as read-only memory (ROM) or flash RAM. The memory 408 is an example of computer-readable media.

The computer-readable media may include a permanent or non-permanent type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer-readable media does not include transitory media, such as modulated data signals and carrier waves.

In implementations, the memory 408 may include program modules 410 and program data 412. The program modules 410 may include a monitoring module 414 used for monitoring a number of data requests; a first determination module 416 used for determining first hotspot data according to the monitored number of data requests; and a first processing module 418 used for adding a data identifier of the first hotspot data into a migration list and starting a process of migrating the first hotspot data to a first database.

In implementations, the apparatus 400 may further include a first judging module 420 used for determining whether the process of migrating the first hotspot data to the first database is completed; and a second processing module 422 used for deleting the data identifier of the first hotspot data from the migration list and adding the data identifier of the first hotspot data into a preset first hotspot data list in response to a completion of the process of migrating the first hotspot data to the first database.

In implementations, the apparatus 400 may further include a second judging module 424 used for determining whether a received request for the first hotspot data is a write request when the process of migrating the first hotspot data to the first database is not completed; a third processing module 426 used for returning a message of write failure when the received request for the first hotspot data is a write request; and a fourth processing module 428 used for allowing a read operation on the first hotspot data when the received request for the first hotspot data is a read request.

In implementations, the apparatus 400 may further include an acquisition module 430 used for obtaining load information of the first database; and a second determination module 432 used for determining second hotspot data that needs to be migrated from the first database to a second database according to the load information.

In implementations, the second determination module 432 may include an acquisition sub-module 434 used for obtaining a data lock queue from the load information; a first determination sub-module 436 used for determining a respective number of ongoing sessions corresponding to each piece of first hotspot data based on the data lock queue; and second determination sub-module 438 used for determining piece(s) of first hotspot data with respective number(s) of ongoing sessions exceeding a preset threshold as the second hotspot data that needs to be migrated from the first database to the second database.

In implementations, the apparatus 400 may further include a third judging module 440 used for determining whether a request for the first hotspot data is received; and a first routing module 442 used for routing the request for the first hotspot data to the first database in response to receiving the request for the first hotspot data.

In implementations, the apparatus 400 may further include a fourth judging module 444 used for determining whether the received request is a request for a piece of first hotspot data in a preset first hotspot data list; and a second routing module 446 used for routing the request to the first database when the received request is a request for a piece of first hotspot data in the preset first hotspot data list.

All the functional modules in the foregoing apparatus can implement all the operations of the foregoing method for real-time data migration, and an exemplary implementation process can be found by making reference to the embodiments of the method for real-time data migration.

In a typical configuration, each of the foregoing functional modules can also be implemented by one or more computing devices, and a computing device may include one or more processors (CPU), an input/output interface, a network interface and memory.

Certain terms are used throughout the specification and claims to refer to particular components. One skilled in the art can understand that hardware manufacturers may assign different names to a same component. The specification and claims do not intend to distinguish components using different names but distinguish components based on differences in respective functionalities. In the entire coverage of the specification and claims, terms “including” and “comprising” are used in an open-ended fashion, and thus should be interpreted to mean “including, but not limited to”. “Generally” means that, within an acceptable error range, one skilled in the art can solve the technical problem and substantially achieve the technical effect in a certain error range. In addition, a term “coupling” herein includes any direct or indirect electrical coupling means. Thus, if a first device is described to be coupled to a second device in a text, the first device may be electrically coupled to the second device directly, or electrically coupled to the second device indirectly via other devices or coupling means. The subsequent description of the specification corresponds to exemplary implementations for implementing the present disclosure. A description thereof aims to illustrate a general principle of the present disclosure, but is not intended to limit the scope of the present disclosure. The scope of protection of the present disclosure shall be defined by the appended claims.

It should be further noted that terms such as “comprise”, “include” or any other variations thereof are intended to cover non-exclusive inclusion, so that a product or system that includes a series of elements would not only include these essentials, but also include other element(s) that is/are not explicitly listed, or further include element(s) that is/are inherent in the product or system. Without more restrictions, an element defined by a phrase “comprising a . . . ” does not preclude a further inclusion of other identical element(s) in a product or system that include that element.

A number of exemplary embodiments of the present disclosure are illustrated and described in the foregoing description. However, as previously described, it should be understood that the disclosed methods and apparatuses are not limited to a form or forms disclosed herein, which should not be considered as an exclusion of other embodiments. They can be used in various other combinations, modifications and environments and can be changed within the scope of the inventive concept described herein through the foregoing teachings or technology/knowledge in the related field. Moreover, modifications and variations performed by one skilled in the art without departing from the spirit and scope of the present disclosure shall fall within the scope of protection of the appended claims of the present disclosure.

What is claimed is:

1. A method implemented by one or more computing devices, the method comprising:
monitoring a number of data requests;
determining one or more pieces of first hotspot data based at least in part on the number of data requests; and
adding respective one or more data identifiers of the one or more pieces of the first hotspot data into a migration list for starting a process of migrating the one or more pieces of the first hotspot data to a first database.

2. The method of claim 1, further comprising:
determining whether the process of migrating the one or more pieces of the first hotspot data to the first database is completed; and
deleting the respective one or more data identifiers of the one or more pieces of the first hotspot data from the migration list and adding the respective one or more data identifiers of the one or more pieces of the first hotspot data into a preset first hotspot data list in response to determining that the process of migrating the one or more pieces of the first hotspot data to the first database is completed.

3. The method of claim 2, further comprising:
determining whether a request for a piece of the first hotspot data is received after the one or more data identifiers of the one or more pieces of the first hotspot data are added into the preset first hotspot data list; and
routing the request for the piece of the first hotspot data to the first database in response to receiving the request for the piece of the first hotspot data.

4. The method of claim 1, further comprising:
receiving a request for a piece of the first hotspot data;
determining whether the process of migrating the one or more pieces of the first hotspot data to the first database is completed; and
determining whether the request for the piece of the first hotspot data is a write request in response to determining that the process of migrating the one or more pieces of the first hotspot data to the first database is not completed.

5. The method of claim 4, further comprising returning a message of write failure in response to determining that the received request for the piece of the first hotspot data is a write request.

6. The method of claim 4, further comprising allowing a read operation on the piece of the first hotspot data in response to determining that the received request for the piece of the first hotspot data is a read request.

7. The method of claim 1, further comprising:
obtaining load information of the first database; and
determining one or more pieces of second hotspot data to be migrated from the first database to a second database based at least in part on the load information.

8. The method of claim 7, wherein determining the one or more pieces of the second hotspot data to be migrated comprises:
obtaining a data lock queue from the load information;
determining respective numbers of ongoing sessions corresponding to a plurality of pieces of the first hotspot data in the first database based at least in part on the data lock queue;
determining at least one piece of the first hotspot data with a respective number of ongoing sessions exceeding a preset threshold as at least one piece of the second hotspot data to be migrated from the first database to the second database.

9. One or more computer-readable media storing executable instructions that, when executed by one or more processors, cause the one or more processors to perform acts comprising:
monitoring a number of data requests;
determining one or more pieces of first hotspot data based at least in part on the number of data requests; and
adding respective one or more data identifiers of the one or more pieces of the first hotspot data into a migration list for starting a process of migrating the one or more pieces of the first hotspot data to a first database.

10. The one or more computer-readable media of claim 9, the acts further comprising:
determining whether the process of migrating the one or more pieces of the first hotspot data to the first database is completed; and
deleting the respective one or more data identifiers of the one or more pieces of the first hotspot data from the migration list and adding the respective one or more data identifiers of the one or more pieces of the first hotspot data into a preset first hotspot data list in response to determining that the process of migrating the one or more pieces of the first hotspot data to the first database is completed.

11. The one or more computer-readable media of claim 10, the acts further comprising:
determining whether a request for a piece of the first hotspot data is received after the one or more data identifiers of the one or more pieces of the first hotspot data are added into the preset first hotspot data list; and
routing the request for the piece of the first hotspot data to the first database in response to receiving the request for the piece of the first hotspot data.

12. The one or more computer-readable media of claim 9, the acts further comprising:
receiving a request for a piece of the first hotspot data;
determining whether the process of migrating the one or more pieces of the first hotspot data to the first database is completed; and
determining whether the request for the piece of the first hotspot data is a write request in response to determining that the process of migrating the one or more pieces of the first hotspot data to the first database is not completed.

13. The one or more computer-readable media of claim 12, the acts further comprising returning a message of write failure in response to determining that the received request for the piece of the first hotspot data is a write request.

14. The one or more computer-readable media of claim 12, the acts further comprising allowing a read operation on the piece of the first hotspot data in response to determining that the received request for the piece of the first hotspot data is a read request.

15. The one or more computer-readable media of claim 9, the acts further comprising:
obtaining load information of the first database; and
determining one or more pieces of second hotspot data to be migrated from the first database to a second database based at least in part on the load information.

16. The one or more computer-readable media of claim 15, wherein determining the one or more pieces of the second hotspot data to be migrated comprises:
obtaining a data lock queue from the load information;
determining respective numbers of ongoing sessions corresponding to a plurality of pieces of the first hotspot data in the first database based at least in part on the data lock queue;
determining at least one piece of the first hotspot data with a respective number of ongoing sessions exceeding a preset threshold as at least one piece of the second hotspot data to be migrated from the first database to the second database.

17. An apparatus comprising:
one or more processors;
memory;
a monitoring module stored in the memory and executable by the one or more processors to monitor a number of data requests;
a first determination module stored in the memory and executable by the one or more processors to determine one or more pieces of first hotspot data based at least in part on the number of data requests; and
a first processing module stored in the memory and executable by the one or more processors to add respective one or more data identifiers of the one or more pieces of the first hotspot data into a migration list for starting a process of migrating the one or more pieces of the first hotspot data to a first database.

18. The apparatus of claim 17, further comprising:
a first judging module to determine whether the process of migrating the one or more pieces of the first hotspot data to the first database is completed; and
a second processing module to delete the respective one or more data identifiers of the one or more pieces of the first hotspot data from the migration list and add the respective one or more data identifiers of the one or more pieces of the first hotspot data into a preset first hotspot data list in response to determining that the process of migrating the one or more pieces of the first hotspot data to the first database is completed.

19. The apparatus of claim 17, further comprising:
a first judging module to determine whether the process of migrating the one or more pieces of the first hotspot data to the first database is completed;
a second judging module to determine whether a received request for a piece of the first hotspot data is a write request in response to determining that the process of migrating the first hotspot data to the first database is not completed;
a third processing module to return a message of write failure in response to determining that the received request for the first hotspot data is a write request; and
a fourth processing module to allow a read operation on the piece of the first hotspot data in response to determining that the received request for the piece of the first hotspot data is a read request.

20. The apparatus of claim 17, further comprising:
an acquisition module to obtain load information of the first database;
an acquisition sub-module to obtain a data lock queue from the load information;
a first determination sub-module to determine a respective number of ongoing sessions quantity to each piece of first hotspot data in the first database based at least in part on the data lock queue; and
a second determination sub-module to determine at least one piece of the first hotspot data having a corresponding number of ongoing sessions exceeding a preset threshold as at least one piece of the second hotspot data to be migrated from the first database to the second database.
